(19) United States
(12) Patent Application Publication
(10) Pub. No.: US 2015/0160579 A1
(43) Pub. Date: Jun. 11, 2015

(54) IMAGE FORMING APPARATUS

(71) Applicant: CANON KABUSHIKI KAISHA, Tokyo (JP)

(72) Inventors: Masami Hano, Abiko-shi (JP); Masahiro Makino, Tsukubamirai-shi (JP)

(21) Appl. No.: 14/559,778

(22) Filed: Dec. 3, 2014

(30) Foreign Application Priority Data
Dec. 6, 2013 (JP) 2013-253657

(51) Int. Cl. G03G 15/02

(52) U.S. Cl. CPC G03G 15/0291

(57) ABSTRACT

An image forming apparatus includes a corona charger configured to charge a photosensitive member surface, an exposure device configured to expose the photosensitive member surface to form an electrostatic image, a developing device configured to develop the electrostatic image with toner to form a toner image, and an execution unit configured to execute a first mode for developing an electrostatic image formed by the exposure device to form a toner image, transferring the toner image onto a recording material, and outputting it, and a second mode for transferring a plurality of toner images formed without substantially forming an electrostatic image using the exposure device onto a recording material as a plurality of adjustment toner images for adjusting a distance between the charger and the photosensitive member surface in a longitudinal direction of the charger, and outputting the plurality of adjustment toner images having average densities different from each other.

### BACKGROUND OF THE INVENTION

1. Field of the Invention

The present invention relates to an image forming apparatus using an electrophotographic process of a copying machine, a printer, a facsimile, or a multifunction peripheral having multiple functions of these devices.

2. Description of the Related Art

There is an image forming apparatus such as a copying machine for developing with a toner an electrostatic latent image formed on a photosensitive member to form a toner image, and then transferring the toner image onto a transfer sheet as a recording material to form an image. In the image forming apparatus, the surface potential of the photosensitive member in the main scanning direction may not be uniform due to variations in the distance between a corona charger and the photosensitive member in the main scanning direction of the photosensitive member (due to the inclination of the corona charger). This may cause, for example, toner fogging in a part of the photosensitive member in the main scanning direction.

Conventionally, to solve the above problem, for example, Japanese Patent Application Laid-Open No. 06-102740 discusses a technique for causing an analog image forming apparatus to copy a white reference document and forming an adjustment toner image on a recording material based on an electrostatic latent image formed by irradiating the document image at that time. Then, based on the density of the adjustment toner image, the inclination of a corona charger with respect to a photosensitive member is adjusted.

Japanese Patent Application Laid-Open No. 06-102740, however, employs an analog development (regular development) method. Thus, the adjustment toner image is formed in an area corresponding to an exposure portion, which is a light portion exposed by an exposure unit.

Thus, the density of the toner image on the recording material changes under the influence of variations in the amount of exposure of the exposure unit. Thus, if the amount of exposure of the exposure unit is not uniform, it is difficult to accurately measure the amount of change in the density due to the inclination of the corona charger. Consequently, it is not possible to adjust the inclination of the corona charger with high accuracy.

In response, Japanese Patent Application Laid-Open No. 2009-31768 discusses the following technique. In an image forming apparatus that adjusts the inclination of a corona charger by using a toner image output onto a recording material, to prevent a decrease in the accuracy of the inclination adjustment of the corona charger due to variations in the amount of exposure of an exposure unit, a toner is applied to a portion having a dark potential on the surface of a photosensitive member, without making an exposure by the exposure unit, thereby forming a toner image for adjusting the inclination of the corona charger.

In Japanese Patent Application Laid-Open No. 2009-31768, the development contrast, which is the potential difference between the direct-current voltage value of a development bias and the potential of the surface of the photosensitive member on which the toner image is formed, is fixed to one type. In this state, a single toner image for adjusting the inclination of the corona charger is formed.

However, in the configuration where the adjustment toner image is formed with the development contrast fixed to one type as in Japanese Patent Application Laid-Open No. 2009-31768, the amount of charge of toner in a developing unit may change according to changes in the environment, or changes in the proportion of toner to carrier in the developing unit or in the proportion of new toner supplied to the developing unit. This may change the density of the adjustment toner image. Thus, it may be difficult to visually recognize a minute change in the density of the adjustment toner image according to a minute change in the potential of the surface of the photosensitive member due to the inclination of the corona charger. Consequently, it is not possible to recognize the inclination of the corona charger, and therefore, it is not possible to adjust the inclination of the corona charger with high accuracy.

In response, a possible configuration is such that even if a single adjustment toner image is formed as in Japanese Patent Application Laid-Open No. 2009-31768, the development contrast of the adjustment toner image is adjusted by predicting a change in the amount of charge of toner. However, it is actually difficult to accurately predict a change in the amount of charge of toner.

Thus, there is a need for a configuration where it is possible to visually recognize a minute change in the density of an adjustment toner image according to a minute change in the potential of the surface of a photosensitive member due to the inclination of a corona charger with higher probability than in the configuration where one type of adjustment toner image is formed as in Japanese Patent Application Laid-Open No. 2009-31768.

### SUMMARY OF THE INVENTION

According to an aspect of the present invention, an image forming apparatus includes a photosensitive member, a corona charger provided to be opposed to a surface of the photosensitive member, and configured to charge the surface of the photosensitive member, an exposure device configured to expose the surface of the photosensitive member charged by the corona charger to form an electrostatic image on the surface of the photosensitive member, a developing device configured to develop with a toner the electrostatic image formed by the exposure device to form a toner image on the surface of the photosensitive member, a transfer device configured to transfer the toner image formed on the surface of the photosensitive member by the developing device onto a recording material, and an execution unit configured to execute a first mode for forming by use of the exposure device an electrostatic image on the surface of the photosensitive member charged by the corona charger, transferring a toner image formed on the surface of the photosensitive member by the developing device onto a recording material, and then outputting the toner image, and a second mode for, without substantially forming by use of the exposure device an electrostatic image on the surface of the photosensitive member charged by the corona charger, forming by use of the developing device a plurality of toner images on the surface of the photosensitive member, transferring the plurality of toner images onto a recording material, and then outputting the plurality of toner images as a plurality of adjustment toner images for adjusting a distance between the corona charger and the surface of the photosensitive member in a longitudinal direction of the corona charger, in which the plurality of adjustment toner images includes a plurality of adjustment toner images having average densities different from each other.

Further features of the present invention will become apparent from the following description of exemplary embodiments with reference to the attached drawings.

### BRIEF DESCRIPTION OF THE DRAWINGS

FIG. 1 is a cross-sectional view schematically illustrating an example of an image forming apparatus according to a first exemplary embodiment of the present invention.

FIG. 2 is a cross-sectional view illustrating an example of an image forming section according to the first exemplary embodiment of the present invention.

FIG. 3 is a diagram illustrating a configuration of a main part of a grid electrode according to the first exemplary embodiment of the present invention.

FIG. 4 is a diagram illustrating an operation panel and an execution button for instructing the execution of an analog image output mode according to the first exemplary embodiment of the present invention.

FIG. 5 is a flowchart of the analog image output mode according to the first exemplary embodiment of the present invention.

FIG. 6 is a diagram illustrating examples of a plurality of adjustment toner images that is output when the analog image output mode according to the first exemplary embodiment of the present invention is executed.

FIG. 7 is a flowchart of when densities are measured according to the first exemplary embodiment of the present invention.

FIG. 8 is a diagram illustrating high-voltage application conditions according to the first exemplary embodiment of the present invention.

FIGS. 9A and 9B are diagrams illustrating an example of a charger inclination adjustment unit according to the first exemplary embodiment of the present invention.

FIGS. 10A and 10B are diagrams illustrating an example of a charger inclination adjustment unit according to a second exemplary embodiment of the present invention.

FIG. 11 is a diagram illustrating examples of a plurality of adjustment toner images that is output when the analog image output mode according to a third exemplary embodiment of the present invention is executed.

FIGS. 12A, and 12B and 12C are diagrams illustrating high-voltage application conditions according to the third exemplary embodiment and a fourth exemplary embodiment of the present invention, respectively.

### DESCRIPTION OF THE EMBODIMENTS

Various exemplary embodiments, features, and aspects of the invention will be described in detail below with reference to the drawings. In the drawings, components designated by the same numerals have similar configurations or functions, and a redundant description of these components is appropriately omitted. The dimensions, the materials, the shapes, and the relative positions of the components are not intended to limit the application range of this technical idea only to them, unless specifically stated otherwise.

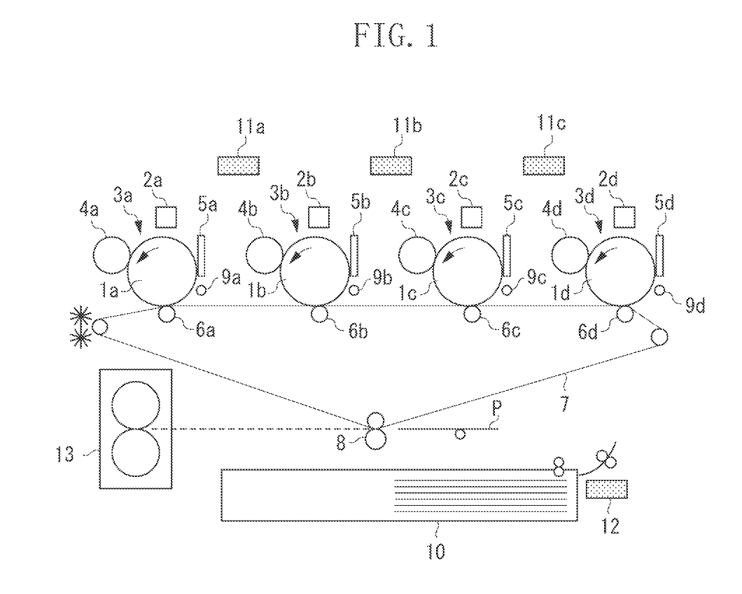

With reference to the figures, an image forming apparatus according to a first exemplary embodiment will be described. First, with reference to FIG. 1, a general configuration of the image forming apparatus will be described. Then, charger inclination adjustment control will be described.

Overall Configuration of Image Forming Apparatus

The general configuration of the image forming apparatus will be described below. FIG. 1 is a diagram illustrating a configuration of a tandem image forming apparatus including image forming sections (image forming units) for forming images of respective colors of yellow, magenta, cyan, and black (YMCK), and an intermediate transfer member. The image forming apparatus includes photosensitive members (image bearing members) 1a to 1d, each of which is included in a corresponding one of the image forming sections of the respective colors, and corona chargers (charging devices) 2a to 2d, which charge the photosensitive members 1a to 1d, respectively.

Around the photosensitive members 1a to 1d, the following components are disposed in order along the rotational directions (counterclockwise directions as indicated by arrows) of the photosensitive members 1a to 1d. That is, the charging devices 2a to 2d, exposure devices 3a to 3d as exposure units, developing devices 4a to 4d as developing units, cleaning devices 5a to 5d, and primary transfer devices 6a to 6d as transfer units are disposed, respectively. Further, an intermediate transfer member (intermediate transfer belt) 7, a secondary transfer device 8, static elimination devices 9a to 9d, and a transfer material storage device 10, internal temperature and humidity detection units 11a to 11c, an external temperature and humidity detection unit 12, and a fixing device 13 are disposed. The above image forming sections will be described in detail below. Although only the image forming section corresponding to the Y color, which is in the uppermost stream in FIG. 1, will be described as a representative in the description of the present exemplary embodiment, also the groups represented by “b” to “d” are treated as having similar functions.

Photosensitive Member

In the present exemplary embodiment, rotary drum-type electrophotographic photosensitive members are included as the photosensitive members 1a to 1d. Each of the photosensitive members 1a to 1d includes a photosensitive layer formed of an organic photoconductor (OPC) having negative charge characteristics. Each of the photosensitive members 1a to 1d has a diameter of 84 mm and a longitudinal length of 370 mm. Each of the photosensitive members 1a to 1d is driven to rotate about the center of the drum in the direction of the arrow in FIG. 1 at a process speed (peripheral velocity) of about 350 mm/sec.

Further, the photosensitive member according to the present exemplary embodiment has the layered structure of a general organic photosensitive member. More specifically, each of the photosensitive members 1a to 1d includes an aluminum cylinder as a conductive base on the radial inside.

Further, each of the photosensitive members 1a to 1d includes on the cylinder an undercoat layer for reducing the interference of light caused by a flaw in the cylinder and for avoiding impeding the transport of electric charge generated in an upper layer, an injection prevention layer for preventing the passage of holes generated in a charge generation layer and for allowing the transmission of only electrons, the charge generation layer for generating electric charge by light irradiation, a charge transport layer for transporting electric charge, and a surface protection layer for improving cleaning performance.

Charging Device (Non-Contact Charging Member)

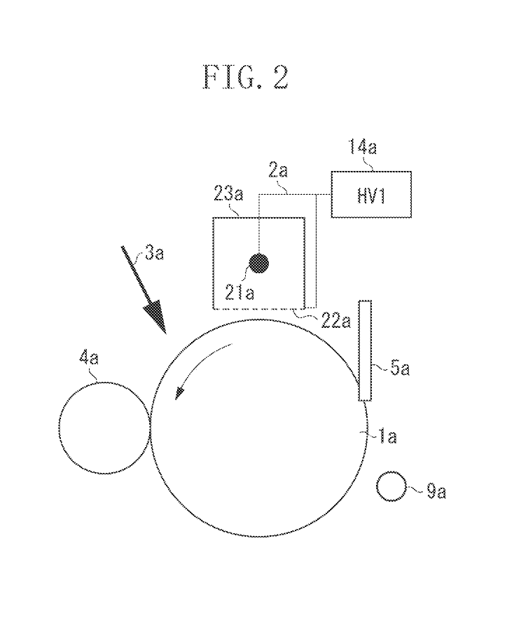

The corona charger (scorotron) as the charging device according to the present exemplary embodiment will be described below. FIG. 2 is a cross-sectional view illustrating an example of the image forming unit according to the present exemplary embodiment. As illustrated in FIG. 2, the corona charger 2a according to the present exemplary embodiment includes a discharge wire 21a as a discharge electrode, a U-shaped conductive shield 23a, which is provided to surround the discharge wire 21a, and a grid electrode 22a, which is placed in an opening portion of the conductive shield 23a. As illustrated in FIG. 2, the corona charger 2a is provided to be opposed to the surface of the photosensitive member 1a. The corona charger 2a discharges from the discharge wire 21a, thereby charging the surface of the photosensitive member 1a.

It is desirable that the discharge wire 21a should be made of stainless steel, nickel, or tungsten. In the present exemplary embodiment, the discharge wire 21a is made of tungsten, which has very high stability among metals.

The discharge wire 21a made of tungsten enables a stable corona discharge under severe conditions such as a heating environment and an ozone environment and can be stably used over a long period of time.

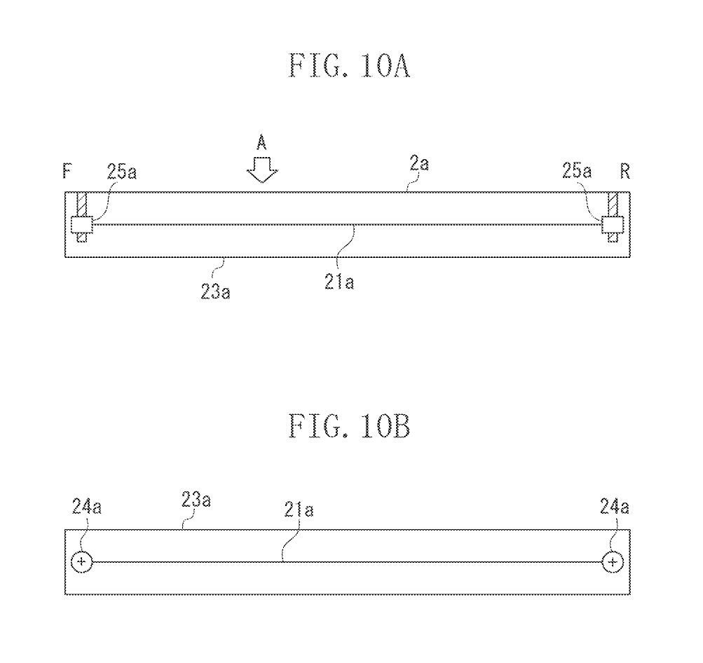

As illustrated in FIGS. 10A and 10B, the discharge wire 21a is held with a certain tension by adjustment screws 24a, which are integrated with the conductive shield 23a, which is made of stainless steel (hereinafter referred to as “SUS”) and performs an electrical shielding function. Electrical insulation is maintained between the discharge wire 21a and the shield 23a by a holding member made of an insulating material.

It is desirable that the discharge wire 21a should have a diameter of 40 to 100 μm. If the diameter of the discharge wire 21a is too small, the discharge wire 21a becomes disconnected by the collision of ions caused by a discharge. Conversely, if the diameter of the discharge wire 21a is too large, the voltage to be applied to the discharge wire 21a to obtain a stable corona discharge becomes high.

If the applied voltage is high, ozone is likely to be generated. This increases the probability of the occurrence of image deletion. Further, the power supply cost increases.

In the present exemplary embodiment, the discharge wire 21a employs a tungsten wire having a diameter of 60 μm. The bias control of the grid electrode 22a, which is connected to a constant-voltage power supply (not illustrated), is performed to produce a rectification effect on electric charge having caused a corona discharge by use of the discharge wire 21a, thereby adjusting the quantity of electric charge to be imparted to the photosensitive member 1a to control the charge potential of the photosensitive member 1a.

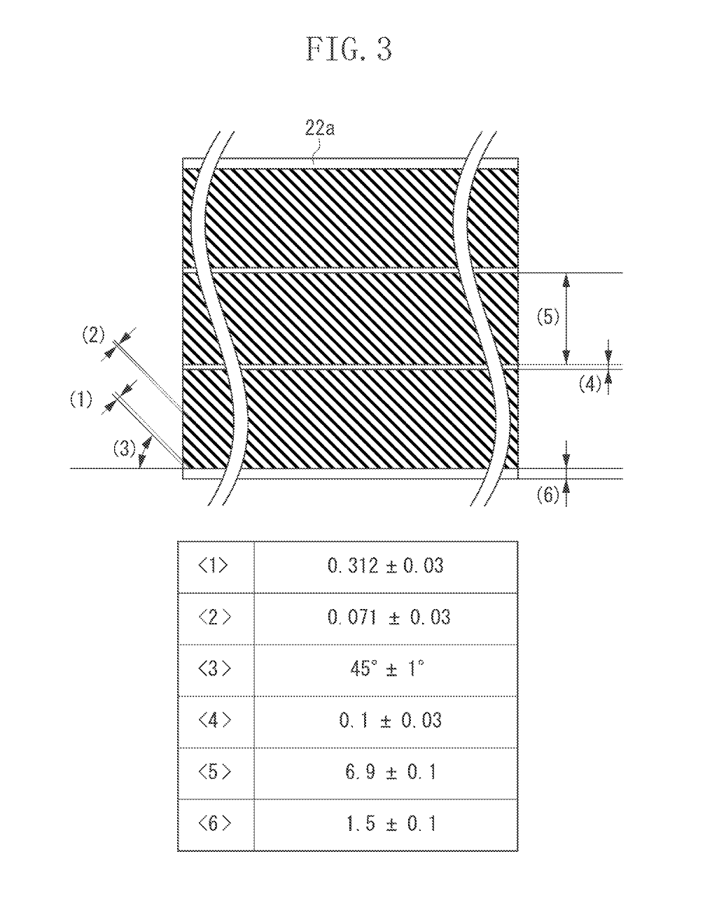

FIG. 3 is a diagram illustrating a configuration of a main part of the grid electrode 22a according to the present exemplary embodiment. In the present exemplary embodiment, an electrode in which a plurality of open holes (through-holes) is formed in a mesh manner is applied to the grid electrode 22a.

The base of the grid electrode 22a used in the present exemplary embodiment is obtained by forming, by etching, a plurality of open holes (through-holes) in a metal plate made of austenitic stainless steel (SUS 304) and having a thickness of 0.03 mm.

The inside of the grid electrode 22a subjected to etching is mesh-shaped. As illustrated in FIG. 3, the open holes are obliquely formed at 45±1° with respect to a base line at such intervals that the strand width is 0.071±0.03 mm, and the open width is 0.312±0.03 mm.

Further, in the grid electrode 22a, to prevent deflection, beams having a width of 0.1±0.03 mm are provided at intervals of 6.9±0.1 mm in the longitudinal direction. An outer frame of the grid electrode 22a has a width of 1.5±0.1 mm.

Further, the grid electrode 22a includes a surface layer made of tetrahedral amorphous carbon (hereinafter referred to as “ta-C”) on the base made of SUS.

In the present exemplary embodiment, ta-C is applied as a material that is chemically inert to a discharge product generated by a corona discharge, and also as a highly corrosion-resistant material. Hereinafter, the base made of SUS is referred to as an “SUS base”, and the surface layer made of ta-C is referred to as a “ta-C layer”.

The grid electrode 22a using the ta-C layer can reduce the oxidation of the SUS base and the occurrence of galvanic corrosion and can maintain stable charging over a long period of time with less charging unevenness.

The material of the base is not limited to the above austenitic stainless steel (SUS 304), but may be another type of austenitic stainless steel. Alternatively, another type of stainless steel such as martensitic stainless steel or ferritic stainless steel may be used.

Further, the corona charger 2a is connected to a high-voltage power supply 14a, which serves as a charging bias application unit for applying a charging bias. The high-voltage power supply 14a applies a charging bias to the discharge wire 21a and the grid electrode 22a.

The charging bias applied by the high-voltage power supply 14a functions to perform the process of uniformly charging the surface of the photosensitive member 1a to a negative potential.

More specifically, the charging bias is controlled so that a constant current of −1 mA is applied to the discharge wire 21a by constant-current control, and a constant voltage of about −900 V is applied to the grid electrode 22a by constant-voltage control in a regular image formation state in the present exemplary embodiment (hereinafter referred to as a “first mode” in the present exemplary embodiment).

A description will be given below of high-voltage conditions to be set to make a charger inclination adjustment, which are the features of exemplary embodiments of the present invention.

Other Devices of Image Forming Section

In the present exemplary embodiment, the exposure device 3a as the exposure unit is a laser beam scanning exposure device using a semiconductor laser source and a polygon mirror optical system. For example, if a constant current of −1 mA has been applied to the discharge wire 21a of the corona charger 2a by constant-current control, and a constant voltage of −900 V has been applied to the grid electrode 22a of the corona charger 2a, the photosensitive member 1a is charged to a charge potential of about −800 V (a dark potential). The charged surface of the photosensitive member 1a is exposed by the exposure device 3a and the charge potential is changed to about −300 V (a light potential). The surface of the photosensitive member 1a is thus exposed by the exposure device 3a, thereby forming an electrostatic latent image as an electrostatic image on the surface of the photosensitive member 1a.

The developing device 4a as the developing unit supplies a developer (toner) to the electrostatic latent image (electrostatic image) formed on the surface of the photosensitive member 1a by the exposure device 3a and develops the electrostatic latent image, thereby visualizing the electrostatic latent image as a toner image and forming the toner image on the surface of the photosensitive member 1a. A reverse developing device using a two-component magnetic brush development method is applied to the developing device 4a.

The developing device 4a includes a developing container and a developing sleeve. In the developing container, a two-component developer is stored. The two-component developer is a mixture of a toner and a magnetic carrier. The two-component developer has a toner density (TD ratio) of 8%, which is obtained by mixing the toner with the carrier in a weight ratio of about 8:92. The toner is obtained by kneading a pigment with a resin binder that mainly contains polyester, and grinding and classifying the resulting product. The toner has an average particle diameter of about 6μ. In the carrier, for example, a metal such as unoxidized iron, nickel, cobalt, manganese, chromium, or a rare earth, an alloy of these metals, or oxide ferrite can be suitably used for a surface oxidation region. The method of manufacturing these magnetic particles is not particularly limited. The carrier has a volume average particle diameter of 20 to 50 μm, preferably 30 to 40 μm, and has a resistivity of 107 Ωcm or more, preferably 108 Ωcm or more.

In this case, the carrier is obtained by coating a core, which mainly contains ferrite, with a silicon resin. The carrier has a volume average particle diameter of 35 μm, a resistivity of 5×108 Ωcm, and a magnetization of 200 emu/cc.

The developing sleeve is placed to be opposed to and in proximity to the photosensitive member 1a while maintaining a distance of closest approach of 250 μm from the photosensitive member 1a. A portion where the photosensitive member 1a and the developing sleeve are opposed to each other serves as a developing section.

The developing sleeve is driven to rotate in the developing section in such a manner that the moving direction of the surface of the developing sleeve is a forward direction with respect to the moving direction of the surface of the photosensitive member 1a. The developing sleeve includes a magnetic roller on the inside so that the two-component developer is rotationally conveyed to the developing unit by the magnetic force of the magnetic roller with the rotation of the developing sleeve.

A magnetic brush layer formed on the surface of the developing sleeve is arranged in a predetermined thin layer by a developer coating blade, and a predetermined development bias is applied to the developing sleeve by a development bias application power supply, which serves as a development bias application unit.

In the regular image formation state as the first mode, the development bias to be applied to the developing sleeve is an oscillation voltage obtained by superimposing an alternating-current voltage on a direct-current voltage. More specifically, when the charge potential of the surface of the photosensitive member 1a is −800 V, a direct-current voltage of −620 V and an alternating-current voltage of 1300 Vpp with a frequency of 10 kHz are applied. By the electric field caused by the development bias, the toner in the two-component developer is selectively attached to the electrostatic latent image on the photosensitive member 1a. This develops the electrostatic latent image as a toner image.

At this time, the amount of charge of the toner developed on the photosensitive member 1a is about 40 μC/g. The developer on the developing sleeve having passed through the developing portion is subsequently returned to a developer reservoir in the developing container with the rotation of the developing sleeve.

The amount of charge of toner to be developed changes due to long-term use or depending on the environment. If the toner is new, the amount of charge of toner is relatively high. The toner and the carrier, however, deteriorate by use, and the amount of charge of toner decreases. Further, the amount of charge of toner changes also depending on the environment. In response, for example, the operation of performing control to discharge deteriorated toner to the outside of the developing device 4a and resupplying new toner from a toner bottle is performed, and the operation of agitating the toner and the carrier is performed, thereby performing control to adjust the amount of charge of toner to a range that does not affect the regular image formation. In the present exemplary embodiment, the above control is performed so that the amount of charge of toner per unit mass falls within the range of 10 to 45 μC/g. The amount of charge of toner, however, changes within the above range. For example, the amount of charge of new toner is relatively high, namely 40 μC/g or more. The amount of charge of toner, however, decreases to, for example, about 30 μC/g due to deterioration from use. For example, if the image forming apparatus is installed in an office equipped with air conditioning, changes in the environment are small. Thus, the average of the amount of charge of toner per unit mass as a result of the above control often falls within the range of about 30 μC/g to about 45 μC/g.

In the present exemplary embodiment, the intermediate transfer member 7 and the transfer roller 6a are applied to a transfer device for the toner image on the photosensitive member 1a. The transfer roller 6a is brought into pressure contact with the surface of the photosensitive member 1a with a predetermined pressing force via the intermediate transfer member 7. A pressure-contact nip portion formed by the transfer roller 6a and the photosensitive member 1a serves as a transfer portion. It is desirable that the resistance value of the transfer roller 6a should be 1×102 to 1×108Ω/□ when +2 kV is applied under a measurement environment with a temperature of 23° C. and a humidity of 50%.

In the present exemplary embodiment, the transfer roller 6a is an ion-conductive sponge roller that is formed by mixing nitrile rubber with an ethylene-epichlorohydrin copolymer and has an outer diameter of 16 mm and a metal core diameter of 8 mm.

The intermediate transfer member 7 is conveyed by being nipped between the photosensitive member 1a and the transfer roller 6a. To deal with diversified recording materials, the intermediate transfer member 7 used in the present exemplary embodiment employs a belt including an elastic layer having a soft surface. The intermediate transfer member 7 prevents a transfer omission on a recording material having surface irregularities and also prevents a transfer defect termed “middle omission”, which is likely to occur in coated paper or overhead projector (OHP) paper. The intermediate transfer member 7 has a three-layer structure including a base, an elastic layer, and a coating layer and has a total thickness of about 360 μm. The base is made of a conductive polyimide resin material having a thickness of 80 to 90 μm. The elastic layer is formed by laminating chloroprene rubber with a thickness of 200 to 300 μm on the base, and has a JIS-A hardness of 60 degrees. The coating layer secures the release properties of borne toner particles and a recording material and is the outermost layer having a thickness of about 5 to 15 μm obtained by dispersing a fluororesin in a polyurethane resin binder.

The resistance of the intermediate transfer member belt 7 is adjusted so that the volume resistivity is 1×109 to 1×1011 Ω□cm, and the surface resistivity is 1×1011 to 1×1013Ω/□. When an image is formed, a transfer bias voltage (e.g., +1500 V) having the positive polarity is applied to the transfer roller 6a. The positive polarity is a polarity opposite to the negative polarity, which is the regular charge polarity of the toner. Thus, the toner image on the photosensitive member 1a is sequentially transferred electrostatically onto the surface of the intermediate transfer member 7.

The toner image transferred onto the intermediate transfer member 7 is transferred by the secondary transfer device 8, which serves as a transfer device, onto a recording material conveyed by the recording material storage device 10 and. The recording material onto which the toner image has been transferred is heated and pressurized by the fixing device 13, thereby fusing and fixing the toner image on the recording material. Then, the recording material is output to the outside of the image forming apparatus.

The cleaning device 5a is a device for cleaning residual transfer toner that has not been transferred onto the intermediate transfer member 7 and remains on the photosensitive member 1a. Although in the present exemplary embodiment, blade cleaning is applied, the present invention is not limited to this. Alternatively, a fur brush may be added.

A control unit (not illustrated) is a regular computer control device such as a central processing unit (CPU) that includes a calculation function and is programmed. The control unit performs overall control of the components of the image forming apparatus, thereby causing the components to form an image.

Analog Image Output Mode (Second Mode)

As will be described below, the image forming apparatus according to the present exemplary embodiment has an analog image output mode as a second mode for: without substantially forming an electrostatic latent image by use of the exposure unit, changing at least one of the charging bias, which is the charging high voltage to be applied to the corona charger 2a, and the development bias to be applied to the developing device 4a, by two or more levels in the range of at least one output image, thereby developing (by analog development) a plurality of corona charger inclination adjustment toner images each having a different development contrast, which is the potential difference between the direct-current voltage value of the development bias and the potential of an area of the surface of the photosensitive member 1a where a toner image is formed; transferring the plurality of adjustment toner images onto a recording material; and automatically outputting the plurality of adjustment toner images. Using the adjustment toner images on the recording material output in this mode, an operator or a serviceman visually checks unevenness of the density of each of the adjustment toner images in the main scanning direction (the direction of the rotational axis line of the photosensitive member 1a) (checks a change in the density in the main scanning direction). If, as a result of the check, it has been determined that the corona charger 2a is inclined with respect to the surface of the photosensitive member 1a, it is possible to adjust the inclination of the corona charger 2a with respect to the direction of the rotational axis line of the photosensitive member 1a (adjust the distance between the corona charger 2a and the surface of the photosensitive member 1a in the longitudinal direction of the corona charger 2a) based on the result of the check of the output adjustment toner images. In the present exemplary embodiment, the inclination angles of the discharge wire 21a and the grid electrode 22a of the charging device 2a illustrated in FIG. 2 can be changed in a plane perpendicular to the main scanning direction of the surface of the photosensitive member 1a. An inclination adjustment mechanism will be described below in another part of the specification.

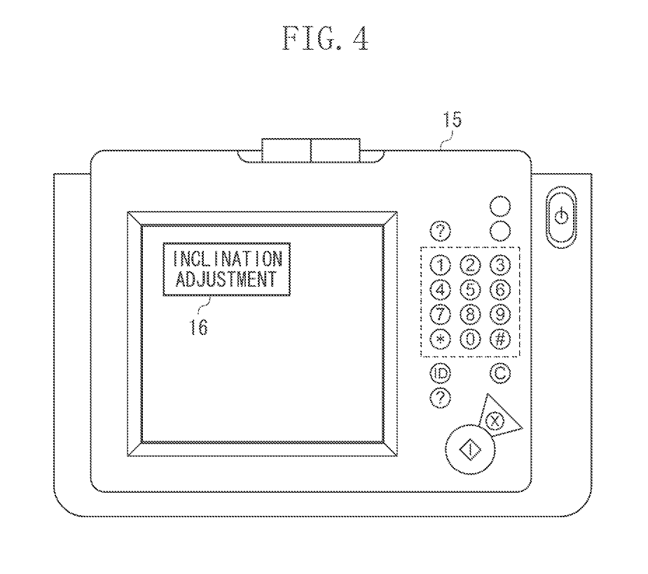

In the present exemplary embodiment, as illustrated in FIG. 4, as an input unit (instruction unit) for executing the analog image output mode, an execution button 16 is provided on an operation panel 15, which serves as an operation unit provided in the main body of the image forming apparatus. The configuration is such that the operator or the serviceman presses the execution button 16 to set image formation conditions for outputting analog images, thereby automatically outputting adjustment toner images.

A description will be given below of the control flow of when the analog image output mode is executed.

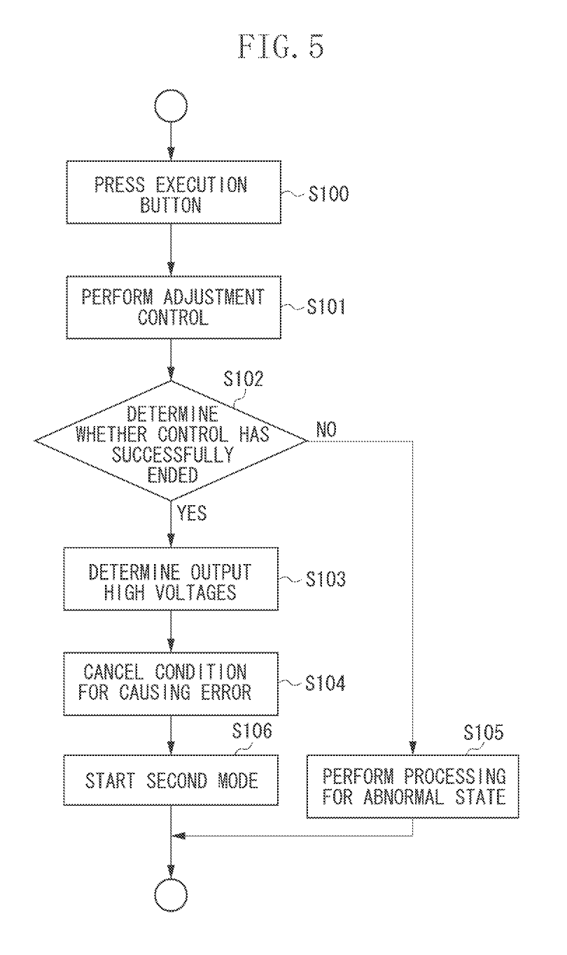

FIG. 5 illustrates a flowchart of when the analog image output mode according to the present exemplary embodiment is executed.

In step S100, the operator or the serviceman presses the execution button 16, which serves as the input unit for executing the analog image output mode, to start controlling the analog image output mode.

In step S101, the control unit as an execution unit performs control for determining image output conditions, namely high-voltage conditions for the development bias and the charging bias in the regular image formation state (hereinafter referred to as the “first mode”).

In step S102, the control unit determines whether the control performed in step S101 has successfully ended. If the control performed in step S101 has failed (in the case of an abnormal state), the processing proceeds to step S105. In step S105, the control unit displays error information.

In step S103, the control unit determines high-voltage conditions for use in the analog image output mode based on the high-voltage conditions determined in the control performed in step S101.

In step S104, the control unit cancels a condition for causing an error due to a difference in the image output conditions between the analog image output mode and the first mode. Then, the control unit performs control so that an error is not determined. If the control unit determines an abnormal state in step S102, then in step S105, the control unit gives an error indication and stops the operation of the image forming apparatus.

In step S106, the control unit commands the image forming apparatus to start outputting analog images.

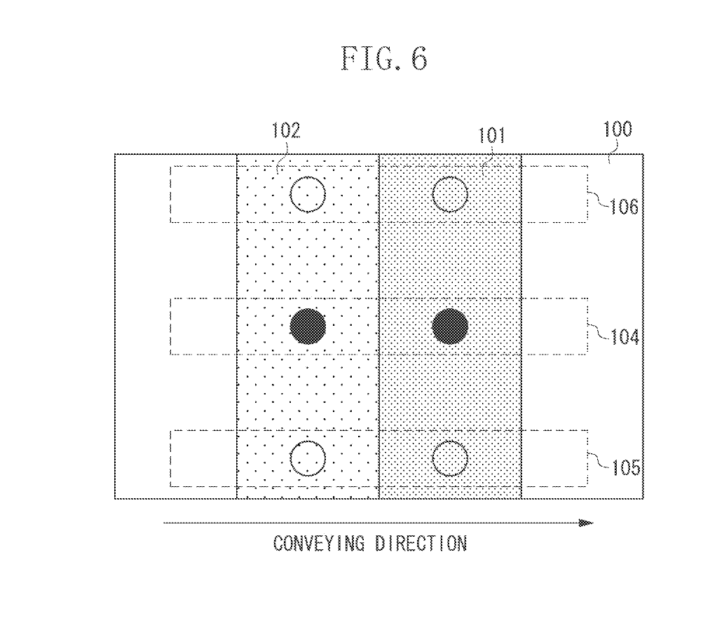

Next, with reference to FIG. 6, adjustment toner images output by the execution of the analog image output mode will be described.

FIG. 6 is a diagram illustrating examples of a plurality of adjustment toner images that is output when the analog image output mode according to the present exemplary embodiment is executed.

In the analog image output mode according to the present exemplary embodiment, a plurality of adjustment toner images in the analog image output mode is formed on a single recording material having a size of 19 inches in the sub-scanning direction and 13 inches in the main scanning direction. FIG. 6 illustrates white solid images 100, which serve as blank portions where toner images are not formed, and adjustment toner images 101 and 102, which are formed in the analog image output mode. For these two adjustment toner images 101 and 102, different development contrasts are set by differentiating the high-voltage conditions from each other. Consequently, the two adjustment toner images 101 and 102 are formed with different densities. As described above, for example, if the image forming apparatus is installed in an office equipped with air conditioning, changes in the environment are small. Thus, the average of the amount of charge of toner per unit mass as a result of the above control often falls within the range of about 30 μC/g to about 45 μC/g. Thus, in the present exemplary embodiment, the configuration is such that adjustment toner images are formed so that the average of the amount of charge of toner per unit mass corresponds to the range of about 30 μC/g to about 45 μC/g, whereby it is possible to visually recognize with higher probability a minute change in the densities of the adjustment toner images according to a minute change in the potential of the surface of the photosensitive member due to the inclination of the corona charger 2a. More specifically, the adjustment toner images 101 and 102 are formed as follows. The development contrast of the first adjustment toner image 101 is set so that when the amount of charge of toner per unit mass is 45 μC/g, the average density of the first adjustment toner image 101 falls within the range of 0.4 to 0.8. The development contrast of the second adjustment toner image 102 is set so that when the amount of charge of toner per unit mass is 30 μC/g, the average density of the second adjustment toner image 102 falls within the range of 0.4 to 0.8. As a result, two adjustment toner images, namely the first adjustment toner image 101 and the second adjustment toner image 102, which has a smaller average density than that of the first adjustment toner image 101, are formed on a single recording material. The “average density” refers to the average density of the entire area of each toner image. For example, the densities of a total of three portions including both end portions and a central portion of the toner image in the main scanning direction may be measured, and the average value of the measured densities may be obtained. It is desirable that the density of each of the adjustment toner images should be in the range of a halftone density, which facilitates the visual check of a minute change in the density due to a minute change in the charge potential of the surface of the photosensitive member 1a. The inventors of the present invention have found that the range of 0.4 to 0.8 is a range that facilitates the visual recognition of a change in the density. Further, the “density” in the present exemplary embodiment refers to a numerical value obtained by measuring, with a reflection densitometer manufactured by X-Rite, Inc., the density of an analog image which is output using high-quality white paper GFC081 manufactured by Canon Inc. as a recording material. The absolute value of the density to be adjusted may be appropriately adjusted depending on the medium to which the analog image is to be output or the reflection densitometer.

In the present exemplary embodiment, a plurality of adjustment toner images is formed on a single recording material, whereby it is possible to save recording materials for use. The present invention, however, is not limited to this. Alternatively, a single adjustment toner image may be formed on each of a plurality of recording materials.

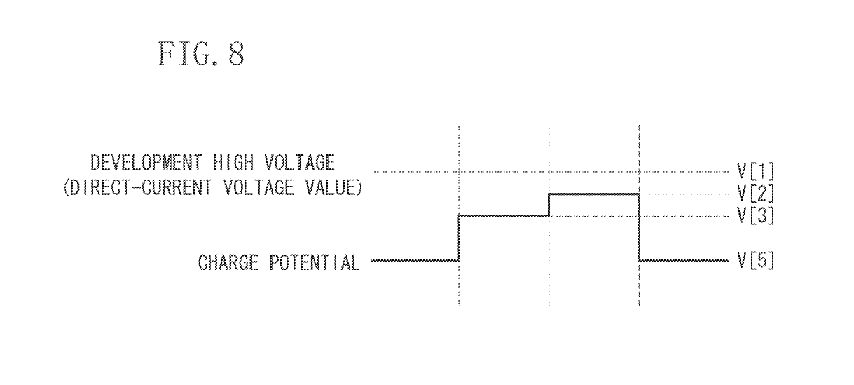

With reference to FIG. 8, a description will be given of the setting of the high-voltage application conditions and the timing of high-voltage application when the analog image output mode according to the present exemplary embodiment is executed.

FIG. 8 is a diagram illustrating the timing of high-voltage application according to the present exemplary embodiment.

In the control illustrated in FIG. 8, the direct-current voltage to be superimposed to obtain the development bias as the development high voltage to be applied to the developing unit is set to the same voltage value as that of the direct-current voltage to be superimposed to obtain the development bias in the regular image formation state, which is the first mode. Further, the charging bias as the charging high voltage is set to a different value for each of the first and second adjustment toner images, thereby setting development contrasts different from each other and forming these analog images. Detailed high-voltage setting conditions will be described below.

In this control, the photosensitive member 1a is rotated with the exposure device 3a turned off. Next, to form the white solid images 100 as blank portions where toner images are not formed, a charging high voltage is applied so that the charge potential (V[5]) of the surface of the photosensitive drum 1a is −800 V.

The charging high voltage in the present exemplary embodiment is controlled under the high-voltage conditions in the regular image formation state so that a constant current of −1 mA is applied to the discharge wire 21a by constant-current control, and a constant voltage of −900 V is applied to the grid electrode 22a by constant-voltage control. The position where the charge potential is −800 V is a predetermined position at the photosensitive member 1a in the longitudinal direction. More specifically, if a potential sensor capable of detecting the charge potential of a part of the photosensitive member 1a in the longitudinal direction is included, the charge potential is −800 V at a position where the potential sensor can detect the charge potential in the longitudinal direction.

A development high voltage (V[1]) is applied together with the application of the charging high voltage. In the present exemplary embodiment, a development bias obtained by superimposing an alternating-current voltage of 1300 Vpp with a frequency of 10 kHz on a direct-current voltage of −620 V is applied as the development high voltage.

Next, in the present exemplary embodiment, to form the adjustment toner images 101 and 102, the value of the direct-current voltage to be applied to the grid electrode 22a is changed, whereby it is possible to generate two types of adjustment toner images for which development contrasts different from each other are set.

In the present exemplary embodiment, the value of the direct-current voltage to be applied to the grid electrode 22a is set to −720 V in the case of V[2] and −780 V in the case of V[3] so that the charge potential of the surface of the photosensitive member 1a is V[2]=−650 V and V[3]=−700 V.

When the photosensitive member 1a passes through a development nip with the charge potential of the surface of the photosensitive member 1a changed at predetermined timing, the photosensitive member 1a is subjected to analog development, thereby forming the first adjustment toner image 101 and the second adjustment toner image 102. Then, after the development of the adjustment toner images 101 and 102 has finished, the high-voltage conditions are changed back to the conditions for forming the white solid images 100 as blank portions where toner images are not formed. Then, the white solid images 100 are formed, and the control ends.

As described above, the white solid images 100 as blank portions where toner images are not formed are formed in both end portions of the recording material in the conveying direction. This can prevent the toner images formed in the analog image output mode from protruding outside the area of the recording material to soil the secondary transfer device 8.

In the present exemplary embodiment, an example of the control in the analog image output mode for the Y color has been described as a representative. Alternatively, adjustment toner images of the Y to K colors may be formed on a single recording material and output. In this case, it is desirable to form the adjustment toner images in such a way that the group of adjustment toner images of each color is not superimposed on the other groups. Further, also when the adjustment toner images are output separately onto a plurality of recording materials, it is similarly desirable to form the adjustment toner images in such a way that the group of adjustment toner images of each color is not superimposed on the other groups.

In the present exemplary embodiment, the voltage to be applied to the grid electrode 22a is set so that the charge potential of the surface of the photosensitive member 1a in an area where a potential sensor can detect the charge potential under an environment with a temperature of 23° C. and a humidity of 50% is a predetermined potential. The present invention, however, is not particularly limited to this setting method.

For example, the configuration may be such that the high-voltage conditions are changed in consideration of changes in the characteristics of the photosensitive member 1a according to the environment, using the temperature and humidity detection units 11a to 11c and 12 illustrated in FIG. 1.

Further, the present invention is not limited to the configuration including a potential sensor. Alternatively, the configuration may be such that a potential sensor is not included, the relationship between the potential of the photosensitive member 1a and the charging bias is stored in advance, and the charging bias is set based on the stored relationship.

After the analog image output mode has been executed, the operator or the serviceman visually checks the output adjustment toner images. If the operator or the serviceman has detected a difference in density between both end portions of any one of the plurality of adjustment toner images in the main scanning direction, the operator or the serviceman determines that the corona charger 2a is inclined. Then, the operator or the serviceman adjusts the distance between the surface of the photosensitive member 1a and the corona charger 2a in the longitudinal direction of the corona charger 2a by using an inclination adjustment unit (described below) of the corona charger 2a.

If there is a densitometer capable of measuring the densities of the adjustment toner images, the densitometer can also be used. In this case, the operator or the serviceman measures the image density of a central position of each adjustment toner image in the main scanning direction by using a reflection densitometer manufactured by X-Rite, Inc. and selects one of the adjustment toner images having a density of 0.6±0.2.

Then, the operator or the serviceman measures the densities of both end portions of the selected adjustment toner image in the main scanning direction. If there is a density difference greater than 0.02 between both end portions, the operator or the serviceman adjusts the distance between the surface of the photosensitive member 1a and the corona charger 2a by using the inclination adjustment unit (described below) of the corona charger 2a so that the density difference is less than or equal to 0.02.

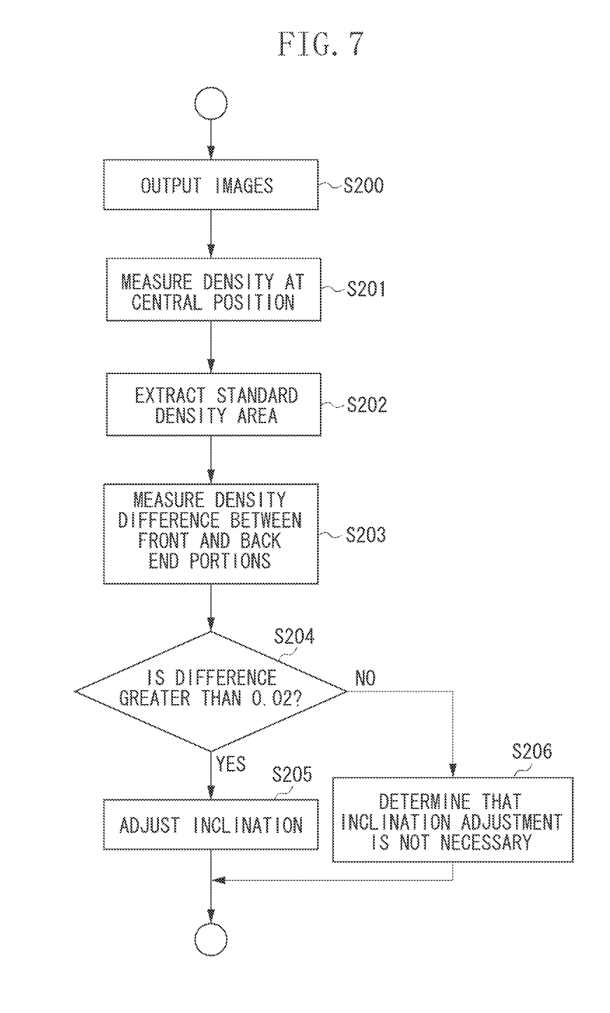

FIG. 7 illustrates the operation flow of the serviceman or the operator when the densities are measured using a densitometer.

In step S200, the image forming apparatus outputs adjustment toner images by the execution of the analog image formation mode.

In step S201, the serviceman or the operator measures the densities of central positions of the output adjustment toner images in the main scanning direction, i.e., the densities of black circle portions in an area 104 illustrated in FIG. 6.

In step S202, the serviceman or the operator selects one of the adjustment toner images of which the measured density is in the range of a density of 0.6±0.2.

In step S203, the serviceman or the operator measures the densities of both end portions of the selected adjustment toner image in the main scanning direction, i.e., the densities of blank circle portions in areas 105 and 106 illustrated in FIG. 6.

In step S204, the serviceman or the operator determines whether the density difference between both end portions is greater than 0.02.

If the serviceman or the operator has determined that the density difference between both end portions is greater than 0.02 (YES in step S204), then in step S205, the processing transitions to the flow of a corona charger inclination adjustment.

If the serviceman or the operator has determined that the density difference between both end portions is less than or equal to 0.02 (NO in step S204), then in step S206, the serviceman or the operator determines that a corona charger inclination adjustment is not necessary.

Charger Inclination Adjustment Unit (Inclination Adjustment Using Grid Electrode 22a)

A charger inclination adjustment unit for adjusting the inclination of the corona charger 2a according to the present exemplary embodiment will be described in detail.

In the present exemplary embodiment, the inclination of the corona charger 2a with respect to the surface of the photosensitive member 1a is adjusted by an inclination adjustment using the grid electrode 22a.

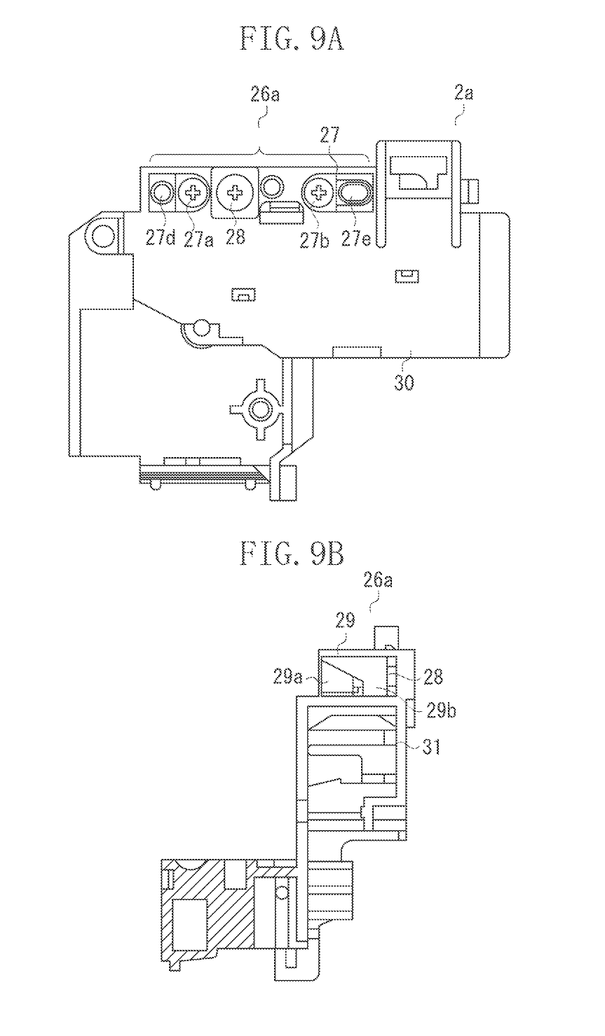

As illustrated in FIGS. 9A and 9B, a grid inclination adjustment unit 26a includes a supporting piece 27 as a supporting portion, fixing screws 27a and 27b as a fixing portion, a position adjustment member 29, and a screw member 28.

FIG. 9A is a front view of an adjustment mechanism. FIG. 9B is a cross-sectional view of the adjustment mechanism.

In the supporting piece 27, which is provided at one end of the corona charger 2a, a first slope 29a is attached to a block 30 with the fixing screws 27a and 27b. The supporting piece 27 is fixed to the block 30 by fastening, with a tool such as a screwdriver, the fixing screws 27a and 27b screwed through a front cover 31. Further, the supporting piece 27 is configured to be slidable in an up-down direction with respect to the block (the direction of approaching or separating from the photosensitive member 1a) by loosening the fixing screws 27a and 27b.

In the supporting piece 27, charger positioning holes 27d and 27e are provided, which are engaged with a corona charger positioning member (not illustrated) of the image forming apparatus. Also at the other end, a positioning member (not illustrated) for determining a position relative to the image forming apparatus is provided. This side, however, is uniquely determined, and therefore, an adjustment mechanism is not provided.

Thus, in a state where the charger positioning holes 27d and 27e of the supporting piece 27 are engaged with the image forming apparatus, the fixing screws 27a and 27b are loosened, whereby the block 30 is supported by the supporting piece 27 so that the block 30 can move to approach and separate from the photosensitive member 1a.

As illustrated in FIGS. 9A and 9B, the position adjustment member 29 is opposed to the supporting piece 27 in the block 30 and is placed to be movable in a front-back direction. Further, in the position adjustment member 29, a second slope 29b is formed, which is engaged with the first slope 29a of the supporting piece 27.

The screw member 28 is screwed into the position adjustment member 29 through the front cover 31 of the block 30. The movement of the screw member 28 in the axial direction is regulated, and the head of the screw of the screw member 28 as an adjustment operation portion is exposed through the front cover 31.

A head portion of the screw member 28 is rotationally operated with a tool such as a screwdriver, whereby the screw member 28 is rotated, and the position adjustment member 29 moves in the front-back direction. At this time, the second slope 29b of the position adjustment member 29 is engaged with the first slope 29a of the supporting piece 27. Thus, the supporting piece 27 moves relative to the block 30 in the up-down direction by a cam action. Thus, the amount of approach or separation of the main body of the corona charger 2a relative to the photosensitive member 1a, i.e., the distance between the grid electrode 22a and the surface of the photosensitive member 1a, can be adjusted by the amount of rotation of the screw member 28.

The grid inclination adjustment unit 26a is provided in one end portion of the corona charger 2a in the longitudinal direction.

Based on the present exemplary embodiment, assuming the following two conditions in a case where it has been determined that there is a density difference between both ends of any one of the adjustment toner images and it is necessary to adjust the inclination of the corona charger 2a, the corona charger inclination adjustment in that case will be described.

[1] The case where the density of an end portion of the adjustment toner image corresponding to an end portion of the corona charger 2a on the side on which the grid inclination adjustment unit 26a is provided is smaller than the density of the other end portion:

The fixing screws 27a and 27b illustrated in FIGS. 9A and 9B are loosened, and the screw member 28 is rotated counterclockwise, thereby causing the grid electrode 22a to approach the photosensitive member 1a.

[2] The case where the density of an end portion of the adjustment toner image corresponding to an end portion of the corona charger 2a on the side on which the grid inclination adjustment unit 26a is provided is greater than the density of the other end portion:

The fixing screws 27a and 27b illustrated in FIGS. 9A and 9B are loosened, and the screw member 28 is rotated clockwise, thereby separating the grid electrode 22a from the photosensitive member 1a.

According to the present exemplary embodiment, in the analog image output mode, the first adjustment toner image and the second adjustment toner image are output. The first adjustment toner image is formed in such a way that when the amount of charge of toner per unit mass is 45 μC/g, the average density of the first adjustment toner image falls within the range of 0.4 to 0.8. The second adjustment toner image is formed in such a way that when the amount of charge of toner per unit mass is 30 μC/g, the average density of the second adjustment toner image falls within the range of 0.4 to 0.8. Thus, if the toner is new and the amount of charge of toner per unit mass is relatively high, namely in the vicinity of 45 μC/g, it is possible, using the first adjustment toner image, to visually check unevenness of the density of the toner image in the main scanning direction. Also if the toner has changed due to long-term use and the amount of charge of toner per unit mass has decreased to the vicinity of 30 μC/g, it is possible, using the second adjustment toner image, to visually check unevenness of the density of the toner image in the main scanning direction. As a result, if the amount of charge of toner has changed, it is possible, using the adjustment toner images, to visually check unevenness of the density of any one of the toner images in the main scanning direction with high probability. Thus, it is possible to adjust with high accuracy the distance between the corona charger and the surface of the photosensitive member in the longitudinal direction of the corona charger.

In the first exemplary embodiment, an example has been described where in a corona charger including a grid electrode, the direct-current voltage value to be applied as the charging high voltage to the grid electrode is set, thereby forming a plurality of adjustment toner images based on a plurality of development contrasts. In a second exemplary embodiment, a case will be described where the direct-current voltage to be applied to a discharge wire is controlled, thereby forming a plurality of adjustment toner images. The components similar to those of the first exemplary embodiment are designated by the same numerals, and a redundant description is appropriately omitted.

As the high-voltage setting conditions in the analog image output mode according to the present exemplary embodiment, the current value of the direct-current voltage to be applied to the discharge wire is changed, thereby setting the development contrasts of a plurality of adjustment toner images.

More specifically, the current value of the direct-current voltage to be applied to the discharge wire 21a is set to −0.6 μA in the case of V[2] and −0.75 μA in the case of V[3] so that the charge potential of the surface of the photosensitive member 1a is V[2]=−650 V and V[3]=−700 V.

When the photosensitive member 1a passes through the development nip with the charge potential of the surface of the photosensitive member 1a changed at predetermined timing, the photosensitive member 1a is subjected to analog development, thereby forming the first adjustment toner image 101 and the second adjustment toner image 102. Then, after the development of the adjustment toner images 101 and 102 has finished, the high-voltage conditions are changed back to the conditions for forming the white solid images 100, and the control ends.

Charger Inclination Adjustment Unit (Inclination Adjustment Using Discharge Wire 21a)

An inclination adjustment unit using the discharge wire 21a according to the present exemplary embodiment will be described. FIGS. 10A and 10B are cross-sectional views of the main part of the corona charger 2a, which extract only the structure of the inclination adjustment unit. FIG. 10A is a cross-sectional view of the corona charger 2a when cut in the main scanning direction. FIG. 10B is a bird's-eye view along an arrow A in FIG. 10A.

The charger inclination adjustment unit includes helical adjustment screws 24a, which are provided to abut the conductive shield 23a, and adjustment casters 25a. The charger inclination adjustment unit is provided in such a way that the adjustment casters 25a at both ends hold the discharge wire 21a with a certain tension.

The adjustment screws 24a can be tightened or loosened with a tool such as a screwdriver. In the present exemplary embodiment, the clockwise rotation of the adjustment screws 24a enables the raising of the adjustment casters 25a. The counterclockwise rotation of the adjustment screws 24a enables the lowering of the adjustment casters 25a.

Based on the present exemplary embodiment, assuming the following two conditions in a case where it has been determined that there is a density difference between areas of the adjustment toner image corresponding to both ends of the corona charger 2a and it is necessary to adjust the inclination of the corona charger 2a, the charger inclination adjustment in that case will be described.

[1] The case where the density of an area of the adjustment toner image corresponding to F in FIGS. 10A and 10B is greater than the density of an area of the adjustment toner image corresponding to R:

In FIGS. 10A and 10B, the adjustment screw 24a on the R side is rotated counterclockwise to lower the adjustment caster 25a, thereby bringing the discharge wire 21a on the R side close to the photosensitive member 1a side.

As a result, it is possible to charge the photosensitive member 1a so that the potential on the back side is equal to the potential of a central position of the image. Thus, it is possible to adjust the density difference between both ends to be within a density standard. It is desirable that also the adjustment caster 25a on the F side should be rotated clockwise to make an adjustment. Thus, it is also possible to deal with the case where an adjustment needs to exceed the limit of range of motion of the adjustment screw 24a on the R side.

[2] The case where the density of an area of the adjustment toner image corresponding to F in FIGS. 10A and 10B is smaller than the density of an area of the adjustment toner image corresponding to R:

In FIGS. 10A and 10B, the adjustment screw 24a on the F side is rotated counterclockwise to lower the adjustment caster 25a, thereby bringing the discharge wire 21a on the F side close to the photosensitive member 1a side.

As a result, it is possible to charge the photosensitive member 1a so that the potential on the back side is equal to the potential of a central position of the image. Thus, it is possible to adjust the density difference between both ends to be within a density standard. It is desirable that also the adjustment caster 25a on the R side should be rotated clockwise to make an adjustment. Thus, it is also possible to deal with the case where an adjustment needs to exceed the limit of range of motion of the adjustment screw 24a on the F side.

According to the present exemplary embodiment, also if the amount of charge of toner has changed, it is possible to adjust with high accuracy the distance between the corona charger and the surface of the photosensitive member in the longitudinal direction of the corona charger.

In the first and second exemplary embodiments, an example has been described where as a plurality of adjustment toner images in the analog image output mode, the first adjustment toner image and the second adjustment toner image are output. The first adjustment toner image is formed in such a way that when the amount of charge of toner per unit mass is 45 μC/g, the average density of the first adjustment toner image falls within the range of 0.4 to 0.8. The second adjustment toner image is formed in such a way that when the amount of charge of toner per unit mass is 30 μC/g, the average density of the second adjustment toner image falls within the range of 0.4 to 0.8.

In a third exemplary embodiment, as described in the first exemplary embodiment, control is performed so that the amount of charge of toner is adjusted to a range that does not affect the regular image formation. Thus, the amount of charge of toner per unit mass may not often decrease to the lower limit of the above range, namely 10 μC/g. However, for example, if the toner or the carrier has further deteriorated, or if high-duty images have further continued under a high-temperature and high-humidity environment, the amount of charge of toner per unit mass may decrease to the lower limit of the above range, namely 10 μC/g. In this case, both the average densities of the first and second adjustment toner images may fall outside the range of 0.4 to 0.8.

In response, in the present exemplary embodiment, a third adjustment toner image is further formed and output. If the amount of charge of toner has become smaller than that assumed in the second adjustment toner image, the third adjustment toner image allows the visual check of a minute change in the charge potential of the surface of the photosensitive member as a change in the density of the toner image.

More specifically, the control unit as the execution unit further outputs as one of the plurality of adjustment toner images a third adjustment toner image, which is formed in such a way that when the amount of charge of toner per unit mass is 10 μC/g, the average density of the third adjustment toner image falls within the range of 0.4 to 0.8.

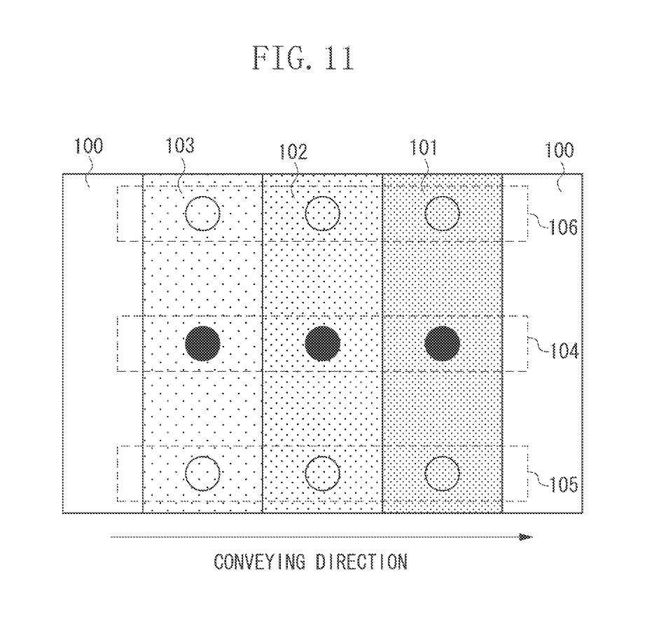

FIG. 11 is a diagram illustrating examples of a plurality of adjustment toner images that is output when the analog image output mode according to the present exemplary embodiment is executed.

In the analog image output mode according to the present exemplary embodiment, a plurality of adjustment toner images in the analog image output mode is formed on a single recording material having a size of 19 inches in the sub-scanning direction and 13 inches in the main scanning direction. FIG. 11 illustrates white solid images 100, which serve as blank portions where toner images are not formed, and a plurality of adjustment toner images 101, 102, and 103, which is formed in the analog image output mode. For these three adjustment toner images 101, 102, and 103, different development contrasts are set by differentiating the high-voltage conditions from each other. Consequently, the three adjustment toner images 101, 102, and 103 are formed with different densities. More specifically, the adjustment toner images 101, 102, and 103 are formed as follows. The development contrast of the first adjustment toner image 101 is set so that when the amount of charge of toner per unit mass is 45 μC/g, the average density of the first adjustment toner image 101 falls within the range of 0.4 to 0.8. The development contrast of the second adjustment toner image 102 is set so that when the amount of charge of toner per unit mass is 30 μC/g, the average density of the second adjustment toner image 102 falls within the range of 0.4 to 0.8. The development contrast of the third adjustment toner image 103 is set so that when the amount of charge of toner per unit mass is 10 μC/g, the average density of the third adjustment toner image 103 falls within the range of 0.4 to 0.8. As a result, the three adjustment toner images, namely the first adjustment toner image 101, the second adjustment toner image 102, which has a smaller average density than that of the first adjustment toner image 101, and the third adjustment toner image 103, which has a smaller average density than that of the second adjustment toner image 102, are formed on a single recording material.

Also in the present exemplary embodiment, a single adjustment toner image may be formed on each of a plurality of transfer materials.

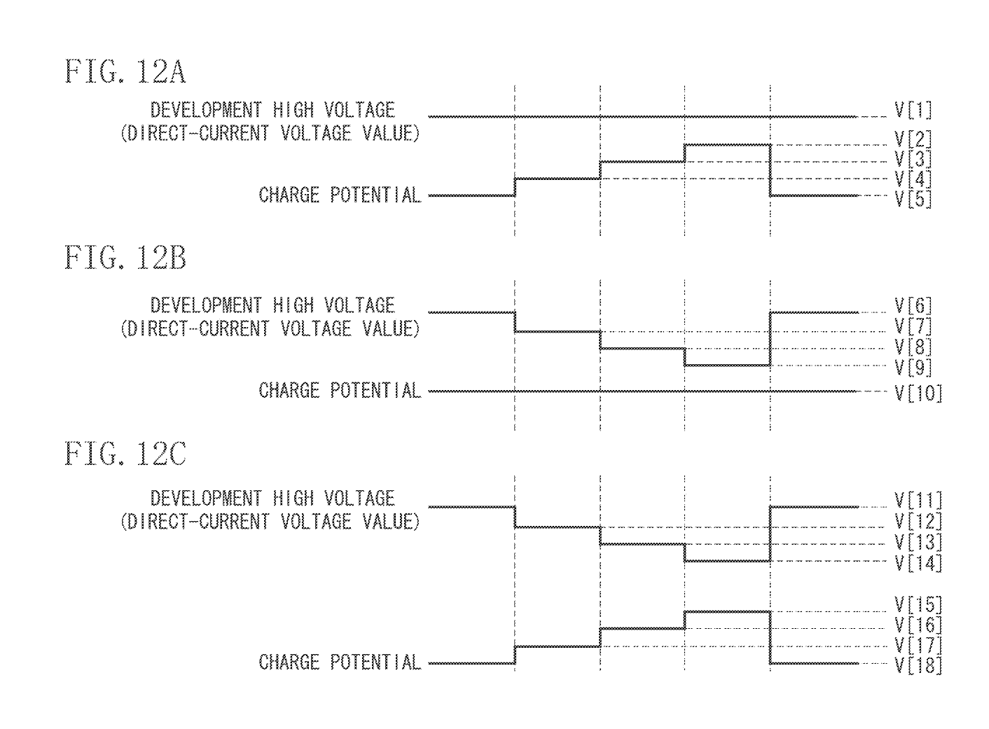

With reference to FIG. 12A, a description will be given of the setting of the high-voltage application conditions and the timing of high-voltage application when the analog image output mode according to the present exemplary embodiment is executed.

FIG. 12A is a diagram illustrating the timing of high-voltage application according to the exemplary embodiment of the present invention.

In the control illustrated in FIG. 12A, the direct-current voltage of the development bias as the development high voltage to be applied to the developing unit is set to the same voltage value as that in the regular image formation state, which is the first mode. Further, the charging bias as the charging high voltage is set to a different value for each of the first, second, and third adjustment toner images, thereby setting development contrasts different from each other and forming these analog images. Detailed high-voltage setting conditions will be described below.

Also in this control, the photosensitive member 1a is rotated with the exposure device 3a turned off. Next, to form the white solid images 100, a charging high voltage is applied so that the charge potential (V[5]) of the surface of the photosensitive member 1a is −800 V.

Also in the present exemplary embodiment, a development high voltage (V[1]) is applied together with the application of the charging high voltage. In the present exemplary embodiment, a development bias obtained by superimposing an alternating-current voltage of 1300 Vpp with a frequency of 10 kHz on a direct-current voltage of −620 V is applied as the development high voltage.

Next, in the present exemplary embodiment, to form the adjustment toner images 101 to 103, the value of the direct-current voltage to be applied to the grid electrode 22a is sequentially changed, whereby it is possible to generate a plurality of adjustment toner images.

In the present exemplary embodiment, the value of the direct-current voltage to be applied to the grid electrode 22a is set to −720 V in the case of V[2], −780 V in the case of V[3], and −840 V in the case of V[4] so that the charge potential of the surface of the photosensitive member 1a is V[2]=−650 V, V[3]=−700 V, and V[4]=−750 V.

When the photosensitive member 1a passes through the development nip with the charge potential of the surface of the photosensitive member 1a changed at predetermined timing, the photosensitive member 1a is subjected to analog development, thereby forming the first adjustment toner image 101, the second adjustment toner image 102, and the third adjustment toner image 103. Then, after the development of the adjustment toner images 101 to 103 has finished, the high-voltage conditions are changed back to the conditions for forming the white solid images 100, and the control ends.

Also in the present exemplary embodiment, as in the second exemplary embodiment, the direct current value to be applied to the discharge wire 21a may be changed, thereby forming the first, second, and third adjustment toner images 101 to 103.

According to the present exemplary embodiment, even if the amount of charge of toner has become smaller than that assumed in the second adjustment toner image, it is possible to visually check a minute change in the charge potential of the surface of the photosensitive member as a change in the density of a toner image. Thus, it is possible to adjust with high accuracy the distance between the corona charger and the surface of the photosensitive member in the longitudinal direction of the corona charger.

In the first to third exemplary embodiments, an example has been described where the charging high voltage is set to a plurality of types, thereby forming a plurality of types of adjustment toner images.

As the high-voltage setting conditions for forming adjustment toner images, however, the development high voltage may be set to a plurality of types without changing the charging high voltage. Alternatively, both the charging high voltage and the development high voltage may be changed.

With reference to FIGS. 12B and 12C, the high-voltage application conditions for the components according to a fourth exemplary embodiment will be described.

In the control in FIG. 12B, a charging high voltage is applied in the same settings as those in the regular image formation state (the first mode), and the development high-voltage conditions are differentiated, thereby forming adjustment toner images. Detailed high-voltage setting conditions will be described below.

In this control, the photosensitive member 1a is rotated with the exposure device 3a turned off. Next, to form the white solid images 100, a high voltage is applied so that the charge potential of the surface of the photosensitive member 1a (V[10]) is −800 V, and the direct-current voltage value of the development bias (V[6]) is −620 V.

The charging bias as the charging high voltage in the present exemplary embodiment is controlled so that a constant current of −1 mA is applied to the discharge wire 21a by constant-current control, and a constant voltage of −900 V is applied to the grid electrode 22a by constant-voltage control.

Next, in the present exemplary embodiment, to form the adjustment toner images 101 to 103, the development high-voltage conditions are sequentially changed, whereby it is possible to generate adjustment toner images.

In the present exemplary embodiment, a direct-current voltage is applied to the developing device 4a so that V[7]=−650 V, V[8]=−700 V, and V[9]=−750 V. Then, an alternating-current (AC) voltage of 1300 Vpp with a frequency of 10 kHz is applied in common.

When the photosensitive member 1a passes through the development nip under the development high-voltage conditions changed at predetermined timing, the photosensitive member 1a is subjected to analog development, thereby forming the adjustment toner images 101 to 103. Then, after a predetermined development of the adjustment toner images 101 to 103 has finished, the adjustment toner images 101 to 103 are transferred onto a recording material, and the recording material is output to the outside of the image forming apparatus. Then, the high-voltage conditions are changed back to the conditions for forming the white solid images 100, and the analog image output mode ends.

In the control in FIG. 12C, only when the white solid images 100 are output, a charging high voltage and a development high voltage similar to those in the first mode are applied. When the adjustment toner images 101 to 103 are output, both the charging high-voltage conditions and the development high-voltage conditions are changed, thereby forming adjustment toner images. Detailed high-voltage setting conditions will be described below.

In this control, the photosensitive member 1a is rotated with the exposure device 3a turned off. Next, to form the white solid images 100, a charging high voltage is applied so that the surface potential (V[18]) of the photosensitive member 1a is −800 V.

In the present exemplary embodiment, a constant current of −1 mA is applied to the discharge wire 21a by constant-current control, and a constant voltage of −900 V is applied to the grid electrode 22a by constant-voltage control. Simultaneously, a development high voltage (V[11]) is applied. In the present exemplary embodiment, a direct-current voltage of −620 V and an alternating-current voltage of 1300 Vpp with a frequency of 10 kHz are applied as the direct-current voltage and the alternating-current voltage to be superimposed to obtain the development bias as the development high voltage.

Next, in the present exemplary embodiment, to form the adjustment toner images 101 to 103, the conditions for the direct-current voltage to be applied to the grid electrode 22a and the conditions for the direct-current voltage to be superimposed to obtain the development bias are sequentially changed, thereby generating adjustment toner images.

In the present exemplary embodiment, the voltage to be applied to the grid electrode 22a is a constant voltage of −820 V in the case of V[16], −850 in the case of V[17], and −880 V in the case of V[18] so that the charge potential of the surface of the photosensitive member 1a is V[15]=−735 V, V[16]=−760 V, and V[17]=−785 V. At predetermined timing with respect to the above changing timing, a direct-current voltage is applied to the developing device 4a in such a way that the direct-current voltage to be superimposed to obtain the development bias is V[12]=−605 V, V[13]=−580 V, and V[14]=−555 V. Then, an alternating-current voltage of 1300 Vpp with a frequency of 10 kHz is applied in common.

When the photosensitive member 1a passes through the development nip under the charging conditions and the development high-voltage conditions changed at the predetermined timing, the photosensitive member 1a is subjected to analog development, thereby forming the adjustment toner images 101 to 103. Then, after a predetermined development of the adjustment toner images 101 to 103 has finished, the adjustment toner images 101 to 103 are transferred onto a recording material, and the recording material is output to the outside of the image forming apparatus. Then, the high-voltage conditions are changed back to the conditions for forming the white solid images 100, and the analog image output mode ends.

With the use of the output images, it is possible to obtain an effect similar to that of the first exemplary embodiment by checking the density difference between both end portions of each of the output images in the main scanning direction and adjusting the inclination of the corona charger according to the checked density difference, as in the first exemplary embodiment. The adjustment method is similar to that of the first exemplary embodiment and therefore is not described here.

Further, in the present exemplary embodiment, predetermined development high-voltage values are applied under an environment with a temperature of 23° C. and a humidity of 50%. The present invention, however, is not limited to these values.

Also according to the present exemplary embodiment, it is possible to obtain effects similar to those of the above first to third exemplary embodiments.

While the exemplary embodiments of the present invention have been described, in the formation of adjustment toner images in the analog image output mode according to the first to fourth exemplary embodiments, the turning off of the exposure device 3a as the exposure unit means that “an electrostatic latent image is not substantially formed by the exposure unit”. This also includes the following case. In an energized state where a light source placed in the exposure unit is turned on, the light source is in a standby light emission state where the light source is emitting weak light. In this case, although the light source is in the standby light emission state, the potential unevenness of the potential of the photosensitive member 1a in the main scanning direction is V or less. This does not influence the inclination adjustment of the corona charger 2a.

Further, in the first exemplary embodiment, an example has been illustrated where the first and second adjustment toner images are formed. In the third exemplary embodiment, an example has been illustrated where the third adjustment toner image is formed in addition to the first and second adjustment toner images. Alternatively, an adjustment toner image other than the first to third adjustment toner images may be formed together.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-253657 filed Dec. 6, 2013, which is hereby incorporated by reference herein in its entirety.

What is claimed is:

1. An image forming apparatus comprising:
a photosensitive member;
a corona charger provided to be opposed to a surface of the photosensitive member, and configured to charge the surface of the photosensitive member;
an exposure device configured to expose the surface of the photosensitive member charged by the corona charger to form an electrostatic image on the surface of the photosensitive member;
a developing device configured to develop with a toner the electrostatic image formed by the exposure device to form a toner image on the surface of the photosensitive member;
a transfer device configured to transfer the toner image formed on the surface of the photosensitive member by the developing device onto a recording material; and
an execution unit configured to execute a first mode for forming by use of the exposure device an electrostatic image on the surface of the photosensitive member charged by the corona charger, transferring a toner image formed on the surface of the photosensitive member by the developing device onto a recording material, and then outputting the toner image, and a second mode for, without substantially forming by use of the exposure device an electrostatic image on the surface of the photosensitive member charged by the corona charger, forming by use of the developing device a plurality of toner images on the surface of the photosensitive member, transferring the plurality of toner images onto a recording material, and then outputting the plurality of toner images as a plurality of adjustment toner images for adjusting a distance between the corona charger and the surface of the photosensitive member in a longitudinal direction of the corona charger,
wherein the plurality of adjustment toner images includes a plurality of adjustment toner images having average densities different from each other.

2. The image forming apparatus according to claim 1, wherein in the second mode, the execution unit transfers the plurality of adjustment toner images onto a single recording material and outputs the plurality of adjustment toner images.

3. The image forming apparatus according to claim 1, wherein in the second mode, the execution unit forms, in both end portions of the recording material in a conveying direction of the recording material, blank portions where toner images are not formed.

4. The image forming apparatus according to claim 1, wherein the developing device includes a developing container for storing a developer obtained by mixing the toner with a magnetic carrier.
